(19) United States
(12) Patent Application Publication
(10) Pub. No.: US 2025/0163261 A1
(43) Pub. Date: May 22, 2025

(54) LOW-DIELECTRIC RESIN COMPOSITION

(71) Applicant: NAN YA PLASTICS CORPORATION, TAIPEI (TW)

(72) Inventors: TE-CHAO LIAO, TAIPEI (TW); LI-YUN CHEN, TAIPEI (TW); WEI-RU HUANG, TAIPEI (TW); HUNG-YI CHANG, TAIPEI (TW); CHIA-LIN LIU, TAIPEI (TW)

(21) Appl. No.: 18/411,396

(22) Filed: Jan. 12, 2024

(30) Foreign Application Priority Data
Nov. 16, 2023 (TW) 112144172

(51) Int. Cl. C08L 63/04; C08L 63/00

(52) U.S. Cl. CPC C08L 63/04; C08L 63/00; C08L 2205/02

(57) ABSTRACT

A low-dielectric resin composition is provided. The low-dielectric resin composition includes: an epoxy resin, an active ester compound, a hardening agent, and an inorganic filler material. Based on a total weight of the low-dielectric resin composition being 100 wt %, a content of the epoxy resin ranges from 5 wt % to 30 wt %, a content of the active ester compound ranges from 5 wt % to 40 wt %, a content of the hardening agent ranges from 0.1 wt % to 20 wt %, and a content of the inorganic filler material is not less than 40 wt %. A ratio of the content of the active ester compound relative to the content of the hardening agent ranges from 0.5 to 20.

### CROSS-REFERENCE TO RELATED PATENT APPLICATION

This application claims the benefit of priority to Taiwan Patent Application No. 112144172, filed on Nov. 16, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition, and more particularly to a low-dielectric resin composition, which is suitable for being used as a build-up material for an IC substrate.

### BACKGROUND OF THE DISCLOSURE

In recent years, with the rapid development of integrated circuit (IC) and the design of high-speed computing chips, requirements in specifications for IC substrates in related electronic products have been elevated (e.g., higher wiring density and faster transmission rates are required for IC substrates).

Accordingly, there is a trend towards developing build-up materials for the IC substrates to have lower dielectric properties. Conventional build-up materials have relatively high dielectric losses, which are not conducive to any applications requiring high frequency and high-speed data transmission.

### SUMMARY OF THE DISCLOSURE

In response to the above-referenced technical inadequacy, the present disclosure provides a low-dielectric resin composition.

In one aspect, the present disclosure provides a low-dielectric resin composition including an epoxy resin, an active ester compound, a hardening agent, and an inorganic filler material. Based on a total weight of the low-dielectric resin composition being 100 wt %, a content of the epoxy resin ranges from 5 wt % to 30 wt %, a content of the active ester compound ranges from 5 wt % to 40 wt %, a content of the hardening agent ranges from 0.1 wt % to 20 wt %, and a content of the inorganic filler material is not less than 40 wt %. Further, a ratio of the content of the active ester compound relative to the content of the hardening agent ranges from 0.5 to 20.

In certain embodiments, the ratio of the content of the active ester compound relative to the content of the hardening agent ranges from 8 to 17.44.

In certain embodiments, the hardening agent is at least one of a bisphenol A type epoxy resin (BPA) and a hydrogenated bisphenol A type epoxy resin.

In certain embodiments, the inorganic filler material is spherical silica particles.

In certain embodiments, a surface of each of the spherical silica particles is modified with at least one of an epoxy group, an acrylic group, and a vinyl group, and a silica purity in each of the spherical silica particles is not less than 95 wt %.

In certain embodiments, an average particle diameter (D50) of the spherical silica particles ranges from 0.05 micrometers to 5 micrometers, and a specific surface area of each of the spherical silica particles ranges from 1 m²/g to 10 m²/g.

In certain embodiments, the low-dielectric resin composition further includes a siloxane coupling agent and an accelerant.

Based on the total weight of the low-dielectric resin composition being 100 wt %, a content of the siloxane coupling agent ranges from 0.01 wt % to 5 wt %, and a content of the accelerant ranges from 0.01 wt % to 5 wt %.

In certain embodiments, the accelerant is at least one of an imidazole compound and an amine-based hardening accelerant.

In certain embodiments, the accelerant is the imidazole compound, and the imidazole compound is selected from the group consisting of: 1-methyl imidazole, 2-methyl imidazole, 2-ethyl imidazole, 2-isopropyl imidazole, 2-n-propyl imidazole, 2-undecyl imidazole, 2-heptadecyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-isopropyl-2-methyl imidazole, 1-cyanoethyl-2-methyl imidazole, 1-cyanoethyl-2-ethyl-4-methyl imidazole, 1-cyanoethyl-2-undecyl imidazole, 1-cyanoethyl-2-phenyl imidazole, 2-phenyl-4-methyl-5-hydroxymethyl imidazole, 2-phenyl imidazole, 2-phenyl-4,5-dihydroxymethyl imidazole, 1,2-phenyl-4-methyl-5-hydroxymethyl imidazole, 1-dodecyl-2-methyl imidazole, 1-cyanoethyl-2-phenyl-4,5-di(2-cyanoethoxy)methyl imidazole, and 2-undecyl imidazole.

In certain embodiments, the epoxy resin is a mixed resin that includes a naphthol-novolac epoxy resin and a bisphenol F-type epoxy resin, in which the naphthol-novolac epoxy resin and the bisphenol F-type epoxy resin are mixed with each other in a weight ratio of 1:2 to 2:1. Further, the active ester compound is at least one of an active ester compound containing a naphthalene structure and an active ester compound containing a dicyclopentadienyl biphenol structure.

In certain embodiments, a resin made of the low-dielectric resin composition has a dielectric constant (Dk) ranging from 2.5 to 4.0 and a dissipation factor (Df) not greater than 0.008 under a signal of 10 GHz.

In certain embodiments, the dielectric constant (Dk) ranges from 2.8 to 3.6, and the dissipation factor (Df) is not greater than 0.004.

Therefore, in the low-dielectric resin composition provided by the present disclosure, by virtue of “the resin composition including an epoxy resin, an active ester compound, a hardening agent, and an inorganic filler material,” and “based on a total weight of the low-dielectric resin composition being 100 wt %, a content of the epoxy resin ranging from 5 to 30 wt %, a content of the active ester compound ranging from 5 to 40 wt %, a content of the hardening agent ranging from 0.1 to 20 wt %, and a content of the inorganic filler material being not less than 40 wt %,” and “a ratio of the content of the active ester compound relative to the content of the hardening agent ranging from 0.5 to 20,” a resin made of the resin composition can have good dielectric properties (e.g., low Df) and dimensional stability, which is beneficial to applications requiring high-frequency and high-speed transmission.

These and other aspects of the present disclosure will become apparent from the following description of the embodiment taken in conjunction with the following drawings and their captions, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [Low-Dielectric Resin Composition]

Since conventional build-up materials used in IC substrates have relatively high dielectric losses, the conventional build-up materials are not conducive to applications requiring high frequency and high-speed data transmission.

In response to the above-referenced technical inadequacy, the present disclosure provides a low-dielectric resin composition that can be used as a build-up material for IC substrates to meet design requirements of high-frequency and high-speed computing chips.

To achieve the aforementioned objective, the low-dielectric resin composition at least includes an epoxy resin (A), an active ester compound (B), a hardening agent (C), and an inorganic filler material (D).

The components (A) to (D) are all non-volatile components. That is, the components (A) to (D) are considered as solid components, which do not evaporate during a drying process.

Furthermore, based on a total weight of the low-dielectric resin composition being 100 wt % (or based on a total weight of the non-volatile components in the resin composition being 100 wt %), a content of the epoxy resin (A) ranges from 5 wt % to 30 wt %, a content of the active ester compound (B) ranges from 5 wt % to 40 wt %, a content of the hardening agent (C) ranges from 0.1 wt % to 20 wt %, and a content of the inorganic filler material (D) is not less than 40 wt %.

More specifically, the content of the epoxy resin (A) ranges from 10 wt % to 20 wt %, the content of the active ester compound (B) ranges from 10 wt % to 30 wt %, the content of the hardening agent (C) ranges from 0.1 wt % to 10 wt %, and the content of the inorganic filler material (D) is not less than 50 wt % (e.g., ranges from 60 wt % to 90 wt %), but the present disclosure is not limited thereto.

In addition, a ratio of the content of the active ester compound (B) relative to (divided by) the content of the hardening agent (C) ranges from 0.5 to 20, preferably ranges from 0.8 to 18, and more preferably ranges from 8 to 17.44.

It is worth mentioning that the ratio of the content of the active ester compound (B) relative to the content of the hardening agent (C) defined above (i.e., ranging from 0.5 to 20, preferably ranging from 0.8 to 18, and more preferably ranging from 8 to 17.44) enables a dielectric constant of the resin composition to be reduced, so that a build-up material made of the resin composition in a IC substrate has a low dielectric property (e.g., having a low Df value).

In addition, the content of the inorganic filler material (D) being not less than 40 wt % enables the build-up material made of the resin composition to have better dimensional stability, thereby improving reliability of the IC substrate. Furthermore, the addition of the hardening agent improves a hardening efficiency of the resin composition.

In some embodiments of the present disclosure, the inorganic filler material (D) can be, for example, spherical silica particles. The spherical silica particles can be formed through a synthetic method (e.g., a sol-gel method), but the present disclosure is not limited thereto.

In some embodiments of the present disclosure, a surface of each of the spherical silica particles is modified with at least one of an epoxy group, an acrylic group, and a vinyl group. A silica purity in each of the spherical silica particles is not less than 95 wt %, and is preferably not less than 99 wt %.

In some embodiments of the present disclosure, an average particle diameter D50 of the spherical silica particles ranges from 0.05 micrometers to 5 micrometers, and preferably ranges from 0.1 micrometers to 2 micrometers. Further, a specific surface area of each of the spherical silica particles ranges from 1 m²/g to 10 m²/g, and preferably ranges from 4 m²/g to 6 m²/g.

According to the above configuration, the inorganic filler material can be evenly dispersed in the resin composition including the epoxy resin, and can increase the dimensional stability of the build-up material made of the resin composition.

The low-dielectric resin composition further includes a siloxane coupling agent (E) and an accelerant (F). The components (E) and (F) are all non-volatile components, but the present disclosure is not limited thereto.

Furthermore, based on the total weight of the low-dielectric resin composition being 100 wt %, a content of the siloxane coupling agent (E) ranges from 0.01 wt % to 5 wt %, and preferably ranges from 0.05 wt % to 3 wt %. Further, a content of the accelerant (F) ranges from 0.01 wt % to 5 wt %, and preferably ranges from 0.03 wt % to 2 wt %.

The siloxane coupling agent (E) can improve compatibility and cross-linking degree between the epoxy resin and the inorganic filler material.

The accelerant (F) can control a reaction of the resin composition to be reacted completely, and can assist in improving uniformity of a film surface of the build-up material made of the resin composition.

In one embodiment of the present disclosure, the accelerant can be, for example, an imidazole compound, such as 2-ethyl-4-methylimidazole (2E4MZ), but the present disclosure is not limited thereto.

The resin made of the low-dielectric resin composition of the present embodiment has a dielectric constant (Dk) ranging from 2.5 to 4.0 (preferably ranging from 2.8 to 3.6) under a signal of 10 GHz. In addition, a dielectric loss (i.e., dissipation factor, Df) of the resin is not greater than 0.008, preferably not greater than 0.004, and more preferably between 0.003 and 0.004 under the signal of 10 GHz, but the present disclosure is not limited thereto.

In terms of processing method, the low-dielectric resin composition can be, for example, formed into a coating material that is in a fluid state (e.g., a varnish) through dissolution and dispersion of a solvent. The coating material formed of the low-dielectric resin composition can be coated on a substrate (e.g., a support) through a coater. Then, the coating material can be dried at a high temperature to remove the solvent, so that the coating material can be formed into a low-dielectric resin coating layer (i.e., the resin made of the low-dielectric resin composition) on the substrate, which can be used as a build-up material for the IC substrate.

A weight ratio between the low-dielectric resin composition (i.e., the non-volatile components) and the solvent (i.e., the volatile components) is between 50:50 and 70:30. In addition, in one embodiment of the present disclosure, the solvent can be, for example, a co-solvent. The co-solvent is composed of toluene and butanone, which are mixed in a volume ratio of 70:30 to 90:10, but the present disclosure is not limited thereto.

A thickness of the low-dielectric resin coating layer (i.e., the build-up material of the IC substrate) can be, for example, between 20 micrometers and 60 micrometers, and preferably between 30 micrometers and 50 micrometers.

Furthermore, an arithmetic mean roughness Ra of a surface of the low-dielectric resin coating layer can be, for example, between 30 nanometers and 100 nanometers, and preferably between 40 nanometers and 60 nanometers, which can facilitate the production of extremely fine lines.

The material types in which the components (A) to (F) can be implemented are listed below, but the present disclosure is not limited thereto.

In some embodiments of the present disclosure, the epoxy resin (A) can be, for example but not limited to, epoxy resins produced by Dainippon Ink and Chemicals, Incorporated (abbreviated as DIC) under the models 7050, HP4710, HP-4700, HP-6000, HP-7200, or N-695; epoxy resins produced by Nippon Kayaku Co., Ltd. under the models NC7000L, NC3000, or NC3500; epoxy resins produced by Nippon Steel Chemical Co., Ltd. under the models ESN475V or ESN485; epoxy resins produced by Mitsubishi Chemical Corporation under the models YX4000 or YL7760; or epoxy resins produced by Nan Ya Plastics Corporation under the models NPES-903, NPEL-128E, or NPEL-170.

The epoxy resin can be, for example, one or more of the aforementioned materials.

In a specific embodiment of the present disclosure, the epoxy resin is a mixed resin that includes HP-6000 (naphthol-novolac epoxy resin) and NPEL-170 (bisphenol F-type epoxy resin), which are mixed with each other in a weight ratio of 1:2 to 2:1 (preferably 1:1), thereby controlling the surface roughness of the material (i.e., the arithmetic mean roughness Ra of the surface of the low-dielectric resin coating layer).

In some embodiments of the present disclosure, the active ester compound (B) can be at least one of an active ester compound containing a dicyclopentadienyl biphenol structure, an active ester compound containing a naphthalene structure, an acetylated active ester compound containing phenolic novolac varnish, and a benzoylated active ester compound containing phenolic novolac varnish. Preferably, the active ester compound is at least one of an active ester compound containing a naphthalene structure and an active ester compound containing a dicyclopentadienyl biphenol structure.

In commercially available active ester compounds, the active ester compound containing the dicyclopentadienyl biphenol structure can be, for example, EXB9451, EXB9460, EXB9460S, or HPC-8000-65T produced by DIC.

Further, the active ester compound containing the naphthalene structure can be, for example, EXB9416-70BK and HPC-8150 produced by DIC, but the present disclosure is not limited thereto.

The acetylated active ester compound containing phenolic novolac varnish can be DC808 produced by Mitsubishi Chemical Corporation.

The benzoylated active ester compound containing phenolic novolac varnish can be YLH1026 produced by Mitsubishi Chemical Corporation.

In a specific embodiment of the present disclosure, the active ester compound is the active ester compound containing the dicyclopentadienyl biphenol structure, such as: HPC-8000-65T that has an active ester equivalent of 220 to 230 g/mol, but the present disclosure is not limited thereto.

In some embodiments of the present disclosure, the hardening agent (C) is at least one of a bisphenol A type epoxy resin (BPA) and a derivative thereof (e.g., a hydrogenated bisphenol A type epoxy resin).

In a specific embodiment of the present disclosure, the hardening agent (C) is the bisphenol A type epoxy resin, but the present disclosure is not limited thereto.

In some embodiments of the present disclosure, the inorganic filler material (D) is spherical silica particles, and a surface of each of the spherical silica particles is modified with epoxy groups.

In a specific embodiment of the present disclosure, the inorganic filler material is at least one of EQH 1003-SES spherical silica particles (available from Third Age Technology, TAT) and EQH 1003-SMS spherical silica particles (available from Third Age Technology, TAT).

In some embodiments of the present disclosure, the siloxane coupling agent (E) is at least one of Z6030 siloxane coupling agent, Momentive A-187S siloxane coupling agent (i.e., silane containing epoxy functional group), and 3-methacryloxypropyltrimethoxysilane produced by Dow Toray Company.

In a specific embodiment of the present disclosure, the siloxane coupling agent is A-187S siloxane coupling agent.

In some embodiments of the present disclosure, the accelerant (F) is the imidazole compound. The imidazole compound is selected from the group consisting of: 1-methyl imidazole, 2-methyl imidazole, 2-ethyl imidazole, 2-isopropyl imidazole, 2-n-propyl imidazole, 2-undecyl imidazole, 2-heptadecyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-isopropyl-2-methyl imidazole, 1-cyanoethyl-2-methyl imidazole, 1-cyanoethyl-2-ethyl-4-methyl imidazole, 1-cyanoethyl-2-undecyl imidazole, 1-cyanoethyl-2-phenyl imidazole, 2-phenyl-4-methyl-5-hydroxymethyl imidazole, 2-phenyl imidazole, 2-phenyl-4,5-dihydroxymethyl imidazole, 1,2-phenyl-4-methyl-5-hydroxymethyl imidazole, 1-dodecyl-2-methyl imidazole, 1-cyanoethyl-2-phenyl-4,5-di(2-cyanoethoxy)methyl imidazole, and 2-undecyl imidazole.

Preferably, the imidazole compound used as the accelerant is selected from the group consisting of: 2-methyl imidazole, 2-ethyl-4-methyl imidazole, 2-phenyl imidazole, and 2-undecyl imidazole. More preferably, the accelerant is 2-ethyl-4-methyl imidazole (2E4MZ), but is not limited thereto.

In some embodiments of the present disclosure, the accelerant can be an amine-based hardening accelerant, which is selected from the group consisting of: triethylamine, tributylamine, 4-dimethylaminopyridine (DMAP), 2,4,6-tris(dimethylaminomethyl)phenol, 1,8-diazabicyclo[5.4.0]undec-7-ene (DBU), and 1,5-diazabicyclo[4.3.0]non-5-ene (DBN).

According to the above configuration, the low-dielectric resin composition provided by the embodiment of the present disclosure can be suitable for preparing build-up materials in IC substrates, and has a low dielectric constant, which is beneficial to the application of high-frequency and high-speed transmission.

The low-dielectric resin composition provided by the embodiment of the present disclosure can be used for forming an insulating layer of a printed circuit board. The printed circuit board can be manufactured by a process that involves a laminating resin film material that uses the insulating layer made of the low-dielectric resin composition to bond with an inner layer substrate.

The inner layer substrate refers to a component that becomes the substrate of the printed circuit board and can be, for example, a glass epoxy substrate, a metal substrate, a polyester substrate, a polyimide substrate, a bismaleimide triazine (BT) resin substrate, or a thermosetting polyphenylene ether substrate. Additionally, the substrate can be covered by a conductor layer on one or both sides thereof, which can be pattern processed.

The lamination of the inner layer substrate with the resin sheet material (i.e., the insulating layer) can be performed by heating and pressing the resin sheet material onto the inner layer substrate from a side of the support body. Components that can be used to heat and press the resin sheet material onto the inner layer substrate include, for example, a heated metal plate (e.g., a stainless steel end plate) or a metal roller (e.g., a stainless steel roller). The heated and pressed component is pressed against the resin sheet material, or is pressed through an elastic material (e.g., a heat-resistant rubber), to ensure that the resin sheet material conforms to the surface irregularities of the inner layer substrate. The lamination of the inner layer substrate with the resin sheet material can be carried out using a vacuum lamination process. In the vacuum lamination process, a hot pressing temperature ranges from 80° C. to 140° C., a hot pressing pressure ranges from 0.05 MPa to 1.5 MPa, and a hot pressing time ranges from 20 seconds to 300 seconds.

The resin sheet material (i.e., the insulating layer) is hardened to form a solidified product composed of the resin composition. The thermal hardening conditions for the resin sheet material vary depending on the resin composition. A hardening temperature is preferably between 120° C. and 240° C.

### [Experimental Data and Test Results]

The present disclosure will be described in detail below with reference to Exemplary Examples 1 to 5 and Comparative Example 1. However, the following examples are only used to aid in understanding of the present disclosure, and should not be construed as limiting the scope of the present disclosure.

Exemplary Example 1: A resin composition is prepared, and the resin composition includes an epoxy resin (A) (including 11.6 parts by weight of HP 6000 and 11.6 parts by weight of NPEL-170), an active ester compound (B) (including 7.86 parts by weight of HPC-8000), a hardening agent (C) (including 9.1 parts by weight of BPA), an inorganic filler material (D) (including 100 parts by weight of EQH1003-SES), a siloxane coupling agent (E) (including 0.2 parts by weight of A-187S), and an accelerant (F) (including 0.1 parts by weight of 2E4MZ). Therefore, a total amount of the components (A) to (F) is 141.32 parts by weight. Herein, a content of the inorganic filler material (D) in the resin composition is 70.7 wt % (i.e., 100/141.32), and the ratio of the content of the active ester compound (B) divided by the content of the hardening agent (C) is 0.86 (i.e., 7.86/9.1).

Then, the resin composition is dissolved and dispersed in a solvent to form a varnish-like coating material. The coating material is coated to a support body using a coater. The support body can be a plastic film or a metal foil. In Exemplary Example 1, the support body is a plastic film. The material of the plastic film can be selected from the group consisting of polyethylene terephthalate (PET), polyethylene naphthalate (PEN), polycarbonate, and polymethyl methacrylate (PMMA). In Exemplary Example 1, the material of the plastic film is polyethylene terephthalate. The coating material is then dried at a high temperature in an oven to remove the solvent, thereby forming a dried resin coating layer on the support body.

The weight ratio between the resin composition (non-volatile components) and the solvent (volatile components) is 70:30. The solvent is a co-solvent composed of toluene and butanone, which are mixed in a volume ratio of 90:10. Additionally, the dried resin coating layer has a thickness of about 40 micrometers.

The preparation methods of Exemplary Examples 2 to 5 are substantially the same as that of Exemplary Example 1, except for the selection and proportion of materials.

The preparation method of Comparative Example 1 is substantially the same as that of Exemplary Example 1. The difference resides in the selection and proportion of materials. In addition, in Comparative Example 1, the hardening agent Bisphenol-A (BPA) is not used. The preparation conditions and test results of the above-mentioned Exemplary Examples 1 to 5 and Comparative Example 1 are summarized in Table 1, respectively.

Then, the dried resin coating layer made of the resin composition prepared in each of Exemplary Examples 1 to 5 and Comparative Example 1 is heated at 200° C. for 90 minutes to obtain a hardened resin coating layer, and then the support body is peeled from the hardened resin coating layer. Finally, the hardened resin coating layer is tested so as to obtain relevant test results.

The relevant test methods are described as follows.

Glass transition temperature Tg (° C.) of the material is determined by using a thermomechanical analyzer (TMA) in accordance with the standard test method ASTM E1545.

A coefficient of thermal expansion (CTE) (ppm/° C.) for an X-Y plane of the material (i.e., X-Y CTE) is determined by using a thermomechanical analyzer (TMA) in accordance with the standard test method IPC-TM-650 2.4.24. The range of heating conditions is between 25° C. and 150° C.

Dk (dielectric constant) and Df (dissipation factor) are determined according to the standard test method IPC-TM-650 (Method 2.5.5.3), where a material sample is placed in a fixture for testing. This method measures a dielectric constant (Dk, & r) and a dissipation factor (Df, Tan 8, also called loss factor) of the material under a signal of 10 GHz.

Arithmetic mean roughness (Ra) is measured in nanometers by using an atomic force microscope (AFM) in accordance with the standard test method JIS B 0601-2001.

The determination of whether varnish exhibits phase separation is made by observing, with the naked eye, whether the coating material in a fluid state (i.e., the varnish) formed by the resin composition and solvents (toluene and butanone) shows any signs of phase separation after being left undisturbed for 24 hours.

The determination of whether a coating surface of the coating layer is smooth is made by visually inspecting a surface appearance of the coating layer formed after the coating material is dried (solvent removed) to assess whether the coating surface is flat.

TABLE 1

| | | Exemplary | Exemplary | Exemplary | Exemplary | Exemplary | Comparative |
|---|---|---|---|---|---|---|---|
| | Terms | Example 1 | Example 2 | Example 3 | Example 4 | Example 5 | Example 1 |
| Resin | (A) Epoxy resin | | | | | | |
| composition | HP6000 | 11.6 | 13 | 8.4 | 8.2 | 8 | 7.6 |
| | (parts by weight) | | | | | | |
| | NPEL-170 | 11.6 | 13 | 8.4 | 8.2 | 8 | 7.6 |
| | (parts by weight) | | | | | | |
| | (B) Active ester | | | | | | |
| | compound | | | | | | |
| | HPC-8000 | 7.86 | 7 | 13 | 14.4 | 15.7 | 17 |
| | (parts by weight) | | | | | | |
| | (C) Hardening | | | | | | |
| | agent | | | | | | |
| | BPA | 9.1 | 5.5 | 2.17 | 1.8 | 0.9 | — |
| | (parts by weight) | | | | | | |
| | Ratio of (B)/(C) | 0.86 | 1.27 | 5.99 | 8.00 | 17.44 | —. |
| | (D) Inorganic filler | | | | | | |
| | material | | | | | | |
| | EQH1003-SES | 100 | 100 | 100 | 100 | 100 | 100 |
| | (parts by weight) | | | | | | |
| | (E) Siloxane | | | | | | |
| | coupling agent | | | | | | |
| | A-187S | 0.2 | 0.2 | 0.2 | 0.2 | 0.2 | 0.2 |
| | (parts by weight) | | | | | | |
| | (F) Accelerant | | | | | | |
| | 2E4MZ | 0.1 | 0.1 | 0.1 | 0.1 | 0.1 | 0.1 |
| | (parts by weight) | | | | | | |
| Test | Tg (TMA)(° C.) | 155 | 153 | 150 | 152 | 151 | N.A. |
| Results | X-Y CTE(TMA) | 16.3 | 15.6 | 15 | 17.4 | 16.8 | N.A. |
| | 25~150° C. | | | | | | |
| | (ppm/° C.) | | | | | | |
| | Dk/Df | 3.5/0.007 | 3.6/0.0057 | 3.1/0.0042 | 3.4/0.004 | 3/0.0038 | N.A. |
| | (10 GHz) | | | | | | |
| | Ra (nm) | 50 | 50 | 50 | 50 | 50 | N.A. |
| | Determination of | No phase | No phase | No phase | No phase | No phase | No phase |
| | whether varnish | separation | separation | separation | separation | separation | separation |
| | exhibits phase | | | | | | |
| | separation | | | | | | |
| | Determination of | Smooth | Smooth | Smooth | Smooth | Smooth | Not smooth |
| | whether coating | | | | | | |
| | surface of coating | | | | | | |
| | layer is smooth | | | | | | |

The test results of Table 1 shows that, in each of Exemplary Examples 1 to 5, the ratio of the content of the active ester compound (B) relative to the content of the hardening agent (C) (i.e., the ratio of B/C) falls within the range of 0.5 to 20 (specifically between 0.86 and 17.44), which helps to reduce the dielectric constant (Dk) and the dielectric loss (Df) of the resin composition. Particularly, by increasing the content of the active ester compound (B) and decreasing the content of the hardening agent (C), thereby elevating the ratio of B/C, a lower dielectric loss (Df) can be achieved. Preferably, in Exemplary Examples 4 and 5, the ratio of the content of the active ester compound (B) relative to the content of the hardening agent (C) (i.e., the ratio of B/C) is between 8 and 17.44. The dielectric loss (Df) of the resin tested under a signal of 10 GHz ranges from 0.0038 to 0.004, exhibiting good dielectric properties. Furthermore, in each of Exemplary Examples 1 to 5, the content of the inorganic filler material (C) falls within the range of 60 wt % to 90 wt % (i.e., Exemplary Example 1 is 70.7 wt %), which contributes to improving the dimensional stability of the material.

Furthermore, since the resin composition of Comparative Example 1 does not include the hardening agent (i.e., BPA), the ratio of B/C cannot be regulated. In the test results, Comparative Example 1 fails to achieve the desired dielectric constant (Dk) and dielectric loss (Df).

It should be noted that patent applications involving compositions typically use two methods of representation, namely “parts by weight (PHR)” and “weight percentage (wt %).” The “parts by weight (PHR)” notation reflects the proportional relationship between the components, so that there is no need to fulfill the constraints of the “weight percentage (wt %)” notation, which requires adherence to two “upper and lower limit formulas” and the sum of the percentages in the examples to equal 100 wt %. The two “upper and lower limit formulas” are as follows: the upper limit value of the content of a single component plus the lower limit values of the contents of the remaining components must be less than or equal to 100 wt %; or, the lower limit value of the content of a single component plus the upper limit values of the contents of the remaining components must be greater than or equal to 100 wt %. If the usage of “parts by weight” is converted to “weight percentage”, it implies that a percentage benchmark, i.e., a total amount benchmark, and thus must follow the upper and lower limit rules. An example of conversion is as follows: For a composition including 50 parts by weight of A and 30 parts by weight of B, after conversion, it becomes a compound comprising 50/(50+30) wt % of A, and 30/(50+30) wt % of B.

### Beneficial Effects of the Embodiments

In conclusion, in the low-dielectric resin composition provided by the present disclosure, by virtue of “the resin composition including an epoxy resin, an active ester compound, a hardening agent, and an inorganic filler material,” and “based on a total weight of the low-dielectric resin composition being 100 wt %, a content of the epoxy resin ranging from 5 to 30 wt %, a content of the active ester compound ranging from 5 to 40 wt %, a content of the hardening agent ranging from 0.1 to 20 wt %, and a content of the inorganic filler material being not less than 40 wt %,” and “a ratio of the content of the active ester compound relative to the content of the hardening agent ranging from 0.5 to 20,” a resin made of the resin composition can have good dielectric properties (e.g., low Df) and dimensional stability, which is beneficial to the applications of high-frequency and high-speed transmission.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A low-dielectric resin composition, comprising:
an epoxy resin;
an active ester compound;
a hardening agent; and
an inorganic filler material;
wherein, based on a total weight of the low-dielectric resin composition being 100 wt %, a content of the epoxy resin ranges from 5 wt % to 30 wt %, a content of the active ester compound ranges from 5 wt % to 40 wt %, a content of the hardening agent ranges from 0.1 wt % to 20 wt %, and a content of the inorganic filler material is not less than 40 wt %;
wherein a ratio of the content of the active ester compound relative to the content of the hardening agent ranges from 0.5 to 20.

2. The low-dielectric resin composition according to claim 1, wherein the ratio of the content of the active ester compound relative to the content of the hardening agent ranges from 8 to 17.44.

3. The low-dielectric resin composition according to claim 1, wherein the hardening agent is at least one of a bisphenol A type epoxy resin (BPA) and a hydrogenated bisphenol A type epoxy resin.

4. The low-dielectric resin composition according to claim 1, wherein the inorganic filler material is spherical silica particles.

5. The low-dielectric resin composition according to claim 4, wherein a surface of each of the spherical silica particles is modified with at least one of an epoxy group, an acrylic group, and a vinyl group, and a silica purity in each of the spherical silica particles is not less than 95 wt %.

6. The low-dielectric resin composition according to claim 5, wherein an average particle diameter D50 of the spherical silica particles ranges from 0.05 micrometers to 5 micrometers, and a specific surface area of each of the spherical silica particles ranges from 1 m²/g to 10 m²/g.

7. The low-dielectric resin composition according to claim 1, further comprising:
a siloxane coupling agent; and
an accelerant;
wherein, based on the total weight of the low-dielectric resin composition being 100 wt %, a content of the siloxane coupling agent ranges from 0.01 wt % to 5 wt %, and a content of the accelerant ranges from 0.01 wt % to 5 wt %.

8. The low-dielectric resin composition according to claim 6, wherein the accelerant is at least one of an imidazole compound and an amine-based hardening accelerant.

9. The low-dielectric resin composition according to claim 8, wherein the accelerant is the imidazole compound, and the imidazole compound is selected from the group consisting of: 1-methyl imidazole, 2-methyl imidazole, 2-ethyl imidazole, 2-isopropyl imidazole, 2-n-propyl imidazole, 2-undecyl imidazole, 2-heptadecyl imidazole, 1,2-dimethyl imidazole, 2-ethyl-4-methyl imidazole, 2-phenyl imidazole, 2-phenyl-4-methyl imidazole, 1-benzyl-2-methyl imidazole, 1-benzyl-2-phenyl imidazole, 1-isopropyl-2-methyl imidazole, 1-cyanoethyl-2-methyl imidazole, 1-cyanoethyl-2-ethyl-4-methyl imidazole, 1-cyanoethyl-2-undecyl imidazole, 1-cyanoethyl-2-phenyl imidazole, 2-phenyl-4-methyl-5-hydroxymethyl imidazole, 2-phenyl imidazole, 2-phenyl-4,5-dihydroxymethyl imidazole, 1,2-phenyl-4-methyl-5-hydroxymethyl imidazole, 1-dodecyl-2-methyl imidazole, 1-cyanoethyl-2-phenyl-4,5-di(2-cyanoethoxy)methyl imidazole, and 2-undecyl imidazole.

10. The low-dielectric resin composition according to claim 1, wherein the epoxy resin is a mixed resin that includes a naphthol-novolac epoxy resin and a bisphenol F-type epoxy resin, and the naphthol-novolac epoxy resin and the bisphenol F-type epoxy resin are mixed with each other in a weight ratio of 1:2 to 2:1; wherein the active ester compound is at least one of an active ester compound containing a naphthalene structure and an active ester compound containing a dicyclopentadienyl biphenol structure.

11. The low-dielectric resin composition according to claim 1, wherein a resin made of the low-dielectric resin composition has a dielectric constant (Dk) ranging from 2.5 to 4.0, and a dissipation factor (Df) not greater than 0.008 under a signal of 10 GHz.

12. The low-dielectric resin composition according to claim 11, wherein the dielectric constant (Dk) ranges from 2.8 to 3.6, and the dissipation factor (Df) is not greater than 0.004.
